(19) United States
(12) Patent Application Publication
(10) Pub. No.: US 2014/0210748 A1
(43) Pub. Date: Jul. 31, 2014

(54) INFORMATION PROCESSING APPARATUS, SYSTEM AND METHOD

(71) Applicant: Panasonic Corporation, Osaka (JP)

(72) Inventors: Atsushi NARITA, Osaka (JP); Kazunari FUJIWARA, Osaka (JP); Ryuji MIKI, Hyogo (JP); Masami YOKOTA, Osaka (JP); Eric CHAN, New York, NY (US); Shigeru NATSUME, New York, NY (US); Silas WARREN, New York, NY (US); Simon ENEVER, New York, NY (US); Hao HUANG, New York, NY (US); Ryoichi YAGI, Osaka (JP); Kiyoshi NAKANISHI, Osaka (JP); Takeshi SHIMAMOTO, Osaka (JP); Seiji KUBO, Osaka (JP); Tomoo KIMURA, Fukuoka (JP); Hiromichi NISHIYAMA, Osaka (JP); Shogo MIKAMI, Osaka (JP)

(73) Assignee: Panasonic Corporation, Osaka (JP)

(21) Appl. No.: 14/164,404

(22) Filed: Jan. 27, 2014

Related U.S. Application Data
(60) Provisional application No. 61/758,343, filed on Jan. 30, 2013.

(30) Foreign Application Priority Data
Dec. 25, 2013 (JP) 2013-267811

(51) Int. Cl. G06F 3/0354; G06F 3/038; G06F 3/041

(52) U.S. Cl. CPC G06F 3/0354; G06F 3/041; G06F 3/038
USPC 345/173

(57) ABSTRACT

An information processing apparatus 10a according to the present disclosure includes: a touchscreen panel 14 on which video is displayed and which accepts an operation that has been performed by a user; a detector 21 which detects the operation that has been performed by the user on the touchscreen panel 14; and a processor 20 which performs processing in response to the operation. If the user has performed the operation using a polyhedron input interface device 10b which has a plurality of sides in mutually different shapes, the detector 21 detects the shape of an area in which the input interface device 10b is in contact with the touchscreen panel to determine which side of the polyhedron has been used to perform the operation, and the processor 20 carries out processing that is associated with the side that has been used.

### BACKGROUND

1. Field of the Invention

The present disclosure relates to a user interface technology for allowing the user to enter his or her instruction into an information processor with a touchscreen panel.

2. Description of the Related Art

Japanese Laid-Open Patent Publication No. 2001-265523 discloses a technique that adopts a polyhedron object such as a cubic object as a new kind of user input device to replace a conventional coordinate pointing device such as a mouse. According to this patent document, when such an object functioning as a user input device is put at a point on a predetermined operating plane, data about that point of contact is entered as a piece of coordinate pointing information into a computer. Also, by choosing an object to put on the operating plane from multiple candidates, a menu option is selected. Furthermore, user commands, functions and processes are allocated to respective planes that form that object.

### SUMMARY OF THE INVENTION

The present disclosure provides a user interface which allows the user to operate a given machine more easily and more intuitively without any need for changing multiple input devices to use.

An information processing apparatus according to the present disclosure includes: a touchscreen panel on which video is displayed and which accepts an operation that has been performed by a user; a detector which detects the operation that has been performed by the user on the touchscreen panel; and a processor which performs processing in response to the operation. If the user has performed the operation using a polyhedron input interface device which has a plurality of sides in mutually different shapes, the detector detects the shape of an area in which the input interface device is in contact with the touchscreen panel to determine which side of the polyhedron has been used to perform the operation, and the processor carries out processing that is associated with the side that has been used.

In one embodiment, if the detector senses that the input interface device contacts with the touchscreen panel at a point, the processor displays a predetermined pattern in the vicinity of the point of contact.

In this particular embodiment, unless the detector senses the user do any additional operation within a predefined period after the predetermined pattern is displayed, the processor zooms in on an image being displayed on the touchscreen panel by a predetermined zoom power.

In another embodiment, in a situation where a first side of the polyhedron is in contact with the touchscreen panel and where the user further performs an additional operation using a stylus type input interface device, when the detector senses that a relative distance between the polyhedron being in contact with the touchscreen panel and the stylus type input interface device is changed, the processor changes the image being displayed on the touchscreen panel by a zoom power corresponding to the relative distance.

In still another embodiment, in a situation where a first side of the polyhedron is in contact with the touchscreen panel, when the detector senses that the polyhedron input interface device being in contact with the touchscreen panel rotates around an axis that intersects at right angles with the touchscreen panel, the processor rotates an image being displayed on the touchscreen panel.

In this particular embodiment, the processor rotates the image being displayed on the touchscreen panel in the same rotational direction and angle as those of the input interface device that is rotated.

In yet another embodiment, in a situation where a first side of the polyhedron is in contact with the touchscreen panel and where the user further performs an additional operation using a stylus type input interface device, when the detector senses that each of the polyhedron and the stylus type input interface device being in contact with the touchscreen panel rotate in the same direction, the processor rotates an image being displayed on the touchscreen panel.

In yet another embodiment, in a situation where a first side of the polyhedron is in contact with the touchscreen panel, when the detector senses that the polyhedron input interface device being in contact with the touchscreen panel is dragged on the touchscreen panel, the processor changes a display range of the image being displayed on the touchscreen panel according to the direction and distance of dragging.

In yet another embodiment, in a situation where a second side of the polyhedron is in contact with the touchscreen panel and where the user further performs an additional operation using a stylus type input interface device, an image object representing a ruler is being displayed on the touchscreen panel, and when the detector senses that the stylus type input interface device moves linearly along the image object, the processor displays a linear object along the image object.

In yet another embodiment, in a situation where a third side of the polyhedron is in contact with the touchscreen panel and where the user further performs an additional operation using a stylus type input interface device, when the detector senses a positional change of the stylus type input interface device, the processor recognizes a character that is drawn based on handwriting data corresponding to the positional change detected and displays the recognized character on the touchscreen panel.

In yet another embodiment, in a situation where a fourth side of the polyhedron is in contact with the touchscreen panel, two types of video content which are inverted 180 degrees with respect to each other are displayed on the touchscreen panel, and have a predetermined relationship with respect to a location concerning the video content, and when the detector senses that the polyhedron is shifted on one of the two types of video content, the processor controls presentation of the other video content so that a position of the other video content is displayed, the position corresponding to a position of the one of the two types of video content, on which the polyhedron is shifted.

In yet another embodiment, the input interface device includes an orientation detecting module which senses any change in the orientation of the input interface device and outputs information about the change in the orientation that is sensed, the information processing apparatus further includes a communications circuit which receives the information about the change in the orientation, and the processor changes display modes of an image being displayed on the touchscreen panel by reference to the information about the change in the orientation.

An information processing system according to the present disclosure includes: an information processing apparatus according to any of the embodiments described above; a first input interface device in a polyhedron shape which is used to operate the touchscreen panel and which has a plurality of sides in mutually different shapes; and a second input interface device in a stylus shape which is used to operate the touchscreen panel. When the detector senses that the first and second input interface devices are operated following a predefined rule while an image is being displayed on the touchscreen panel, the processor changes display of the image.

An information processing method according to the present disclosure is carried out using an information processing system which includes: an information processing apparatus according to any of the embodiments described above; a first input interface device in a polyhedron shape which is used to operate the touchscreen panel and which has a plurality of sides in mutually different shapes; and a second input interface device in a stylus shape which is used to operate the touchscreen panel. The method includes: getting operations that are performed using the first and second input interface devices detected by the detector while an image is being displayed on the touchscreen panel; determining whether or not the operations that are detected by the detector conform to a predefined rule; and if the operations turns out to conform to the predefined rule, getting display of the image changed by the processor.

Another information processing apparatus according to the present disclosure includes: a touchscreen panel on which video is displayed and which accepts an operation that has been performed by a user; a detector which detects the operation that has been performed by the user on the touchscreen panel; and a processor which performs processing in response to the operation. If the user performs the operation using an input interface device with a plurality of sides, each of which has either a different number of terminals, or terminals that are arranged in a different pattern, from any of the other sides, the detector determines the number or arrangement of terminals of the input interface device that are in contact with the touchscreen panel and the processor performs processing according to the number or arrangement of the terminals being in contact.

In one embodiment, the input interface device includes an orientation detecting module which senses any change in the orientation of the input interface device. The information processing apparatus further includes a communications circuit which receives the information about the change in the orientation, and the processor changes display modes of an image being displayed on the touchscreen panel by reference to the information about the change in the orientation.

An embodiment of the present disclosure provides a user interface which allows the user to operate a given machine more easily and more intuitively without any need for changing multiple input devices to use.

These general and specific aspects may be implemented using a system, a method, and a computer program, and any combination of systems, methods, and computer programs.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIG. 1 illustrates a configuration for an information processing system 100 according to an exemplary embodiment of the present disclosure.

FIG. 2 illustrates a hardware configuration for a tablet computer 10a.

FIGS. 3(a), 3(b) and 3(c) are respectively a front view, a rear view and a bottom view of a control cube 10b.

FIGS. 4(a) and 4(b) illustrate states before and after the control cube 10b is put on the touchscreen panel 11 of the tablet computer 10a by the user.

FIG. 5(a) illustrates a situation where the pattern 50 has just been displayed after the detector 21 has sensed the contact of the control cube 10b with the touchscreen panel 11, and FIG. 5(b) illustrates an image object 60b which is now displayed as a detailed image.

FIG. 6(a) illustrates a situation where the detector 21 has sensed that the stylus pen 10c has also contacted with the touchscreen panel while finding the control cube 10b still in contact with the touchscreen panel, and FIG. 6(b) illustrates an image object 60c that has been zoomed out in response to dragging.

FIG. 7(a) illustrates an image 60d to be displayed in the vicinity of the touch point of the control cube 10b on the display panel 12 when the control cube 10b is rotated on the spot in the situation shown in FIG. 5(a), and FIG. 7(b) illustrates an image 60f which is displayed after having been rotated in the direction in which the control cube 10b has been rotated by an angle corresponding to the magnitude of dragging.

FIG. 8 illustrates a rotating operation which may be performed using the control cube 10b and the stylus pen 10c.

FIG. 9 illustrates an image 60g to be displayed when the control cube 10b is further dragged on the touchscreen panel 11 in the situation shown in FIG. 5(a).

FIG. 10 illustrates multiple menu icons 70a to 70c displayed in the vicinity of the control cube 10b.

FIG. 11(a) illustrates what image objects may be displayed at an initial stage of the ruler mode, and FIG. 11(b) illustrate ruler image objects 80a and 80b that have been rotated to a predetermined degree.

FIG. 12 illustrates an exemplary image object to be displayed when a balloon insert mode is entered.

FIG. 13 illustrates exemplary video to be displayed in a dual view mode.

FIGS. 14(a) and 14(b) illustrate the appearance of a control cylinder 210 as Modified Example 1, and FIG. 14(c) illustrates the appearance of a control cylinder 210a with a conductive structure 216.

FIG. 15(a) is a perspective view illustrating a control cylinder 220 as Modified Example 2 and FIG. 15(b) is an exploded view thereof.

FIG. 16 illustrates a hardware configuration for an orientation detecting module 222.

FIGS. 17(a) and 17(b) are perspective views respectively illustrating the top and bottom of a conductive structure 223 according to Modified Example 2, and FIG. 17(c) is an exploded view thereof.

FIGS. 18(a), 18(b) and 18(c) are respectively a perspective view, a side view and an exploded view of a control cylinder 230 as Modified Example 3.

FIGS. 19(a) and 19(b) are respectively a perspective view and an exploded view of a control cylinder 240 according to Modified Example 4.

FIGS. 20(a) and 20(b) are respectively a perspective view and an exploded view of a control cylinder 250 according to Modified Example 5.

FIGS. 21(a), 21(b) and 21(c) are respectively a perspective view, a side view and an exploded view of a control cylinder 260 as Modified Example 6.

FIG. 22 illustrates a control cylinder 10d with an orientation detecting module 222.

### DETAILED DESCRIPTION OF PREFERRED EMBODIMENTS

Hereinafter, embodiments will be described in detail with reference to the accompanying drawings as needed. It should be noted that the description thereof will be sometimes omitted unless it is absolutely necessary to go into details. For example, description of a matter that is already well known in the related art will be sometimes omitted, so will be a redundant description of substantially the same configuration. This is done solely for the purpose of avoiding redundancies and making the following description of embodiments as easily understandable for those skilled in the art as possible.

It should be noted that the present inventors provide the accompanying drawings and the following description to help those skilled in the art understand the present disclosure fully. And it is not intended that the subject matter defined by the appended claims is limited by those drawings or the description.

In this description, a tablet computer will be described as an exemplary information processing apparatus according to the present disclosure.

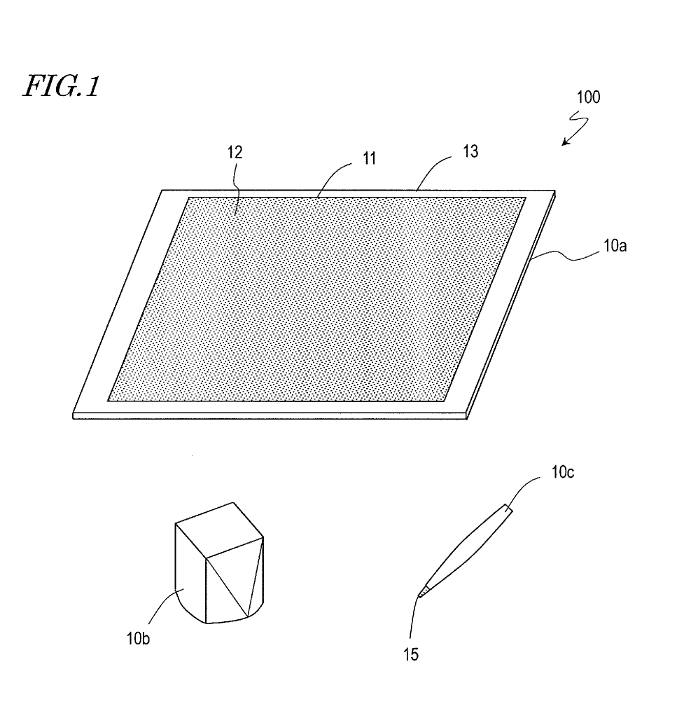

FIG. 1 illustrates a configuration for an information processing system 100 according to an embodiment of the present disclosure. This information processing system 100 includes a tablet computer 10a, a control cube 10b, and a stylus pen 10c. The control cube 10b and the stylus pen 10c are two different kinds of input interface devices. The user operates this tablet computer 10a by touching the tablet computer 10a with the control cube 10b and the stylus pen 10c.

The tablet computer 10a includes a touchscreen panel 11, a display panel 12 and a housing 13.

The touchscreen panel 11 accepts the user's touch operation. The touchscreen panel 11 needs to be at least large enough to cover the operating area and is stacked on the display panel 12.

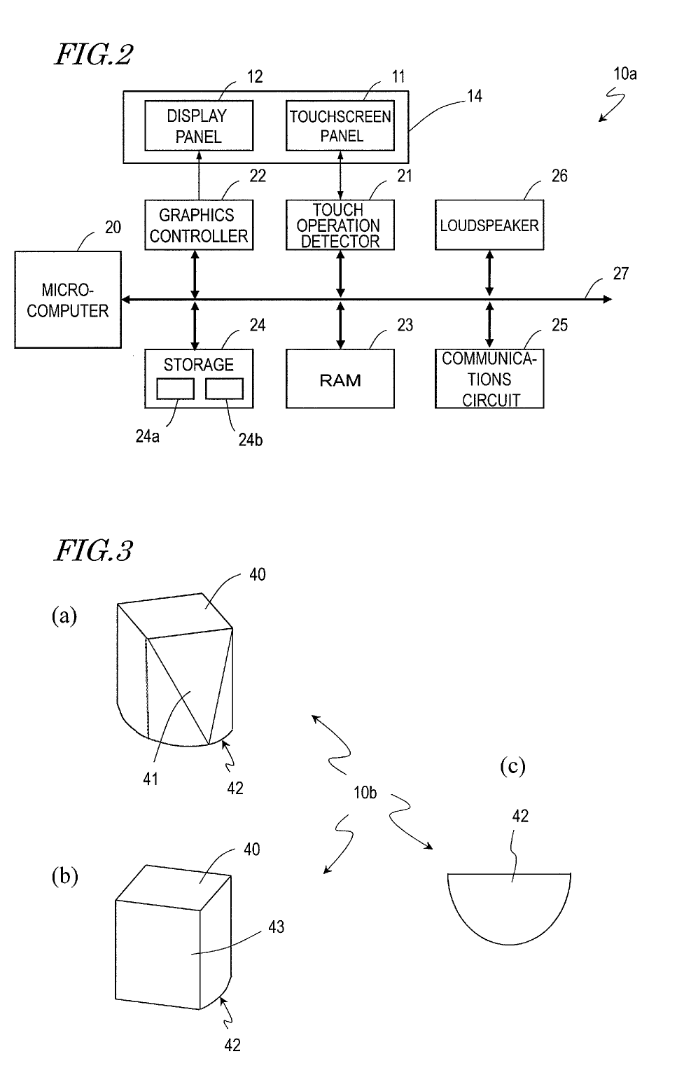

Even though the touchscreen panel 11 and the display panel 12 are supposed to be provided separately from each other in this embodiment, their functions may be combined together in a single panel. For example, a touchscreen panel 14 having the functions of both the touchscreen panel 11 and the display panel 12 is shown in FIG. 2 as will be described later. The touchscreen panel 14 may have not only a configuration in which the touchscreen panel 11 and display panel 14 that are two separate components are stacked one upon the other but also a so-called “in-cell structure” in which touch sensor wiring is provided in cells which are structural parts that form the display panel.

The display panel 12 is a so-called “display device”, and displays an image based on image data that has been processed by a graphics controller 22 to be described later. For example, text data such as characters and numerals or patterns may be displayed on the display panel 12. In this description, the display panel 12 will be described as displaying a plan of a building, for example.

In this embodiment, the display panel 12 is supposed to be a 32 or 20 inch LCD panel and have a screen resolution of 3,840×2,560 dots.

However, the display panel 12 does not have to be an LCD panel but may also be an organic EL panel, an electronic paper, a plasma panel or any other known display device. Optionally, the display panel 12 may include a power supply circuit, a driver circuit and a light source depending on its type.

The housing 13 houses the touchscreen panel 11 and the display panel 12. Although not shown in FIG. 1, the housing 13 may further include a power button, a loudspeaker and so on.

Now take a look at FIG. 1 again. The control cube 10b included in the information processing system 100 shown in FIG. 1 will be described in detail later with reference to FIG. 3.

The stylus pen 10c is a kind of pointing device. By bringing the tip 15 of the stylus pen 10c into contact with the touchscreen panel 11, the user can perform a touch operation. The tip 15 of the stylus pen 10c is made of an appropriate material which is selected according to the method of sensing a touch operation to be performed on the touchscreen panel 11 of the tablet computer 10a. In this embodiment, since the touchscreen panel 11 senses the touch operation by the capacitive method, the tip 15 of the stylus pen 100 is made of a conductive metallic fiber or conductive silicone rubber, for example.

FIG. 2 illustrates a hardware configuration for the tablet computer 10a.

The tablet computer 10a includes the touchscreen panel 11, the display panel 12, a microcomputer 20, a touch operation detector 21, the graphics controller 22, a RAM 23, a storage 24, a communications circuit 25, a loudspeaker 26, and a bus 27.

The touchscreen panel 11 and the touch operation detector 21 (which will be simply referred to herein as a “detector 21”) detect the user's touch operation by a projecting capacitive method, for example.

In the touchscreen panel 11, an insulator film layer made of glass or plastic, an electrode layer, and a substrate layer in which the detector 21 that carries out computational processing is built are stacked in this order so that the user can touch the insulator film layer directly with the stylus pen. In the electrode layer, transparent electrodes are arranged in a matrix pattern along an X axis (which may be a horizontal axis) and a Y axis (which may be a vertical axis). Those electrodes may be arranged either at a smaller density than, or at approximately as high a density as, the respective pixels of the display panel. In the following description of this embodiment, the former configuration is supposed to be adopted.

As the touchscreen panel 11, a capacitive, resistive, optical, ultrasonic, or electromagnetic touchscreen panel may be used, for example.

The detector 21 scans X- and Y-axis matrix sequentially. And on detecting a variation in electrostatic capacitance at any point, the detector 21 senses that a touch operation has been performed on that point and generates coordinate information at as high a density (or resolution) as respective pixels of the display panel 12, to say the least. The detector 21 can detect touch operations at multiple points simultaneously. The detector 21 continuously outputs a series of coordinate data that has been detected by sensing the touch operations. The coordinate data will be received by the microcomputer 20 (to be described later) and detected as representing various kinds of touch operations (such as tapping, dragging, flicking and swiping). It should be noted that the function of detecting those touch operations is generally performed by an operating system that operates the tablet computer 10a.

In this embodiment, the user performs a touch operation using the two different kinds of input devices, namely, a control cube and a stylus to be described later. The control cube and stylus are made of a material that causes a variation in electrostatic capacitance as will be described in detail later. The touchscreen panel 11 may also accept the user's touch operation with his or her finger.

The microcomputer 20 is a processor (such as a CPU) which performs various kinds of processing (to be described later) by reference to information about the point of contact made by the user which has been gotten from the detector 21.

The graphics controller 22 operates in accordance with a control signal that has been generated by the microcomputer 20. Also, the graphics controller 22 generates image data to be displayed on the display panel 12 and controls the display operation by the display panel 12.

The RAM 23 is a so-called “work memory”. In the RAM 23, expanded is a computer program to be executed by the microcomputer 20 in order to operate the tablet computer 10b.

The storage 24 may be a flash memory, for example, and stores image data 24a to be used in performing a display operation and the computer program 24b mentioned above. In this embodiment, the image data 24a includes still picture data such as a plan and three-dimensional moving picture data which is used to allow the user to make a virtual tour of the building as will be described later.

The communications circuit 25 may get this information processing system 100 connected to the Internet or may allow the system 100 to communicate with other personal computers. The communications circuit 25 may be a wireless communications circuit compliant with the Wi-Fi standard and/or the Bluetooth (registered trademark) standard, for example.

The loudspeaker 26 outputs audio based on an audio signal which has been generated by the microcomputer 20.

The bus 27 is a signal line which connects together all of these components of the information processing system 100 but the touchscreen panel 11 and the display panel 12 and which enables those components to exchange signals between them.

Next, the control cube 10b will be described with reference to FIG. 3.

FIGS. 3(a), 3(b) and 3(c) are respectively a front view, a rear view and a bottom view of the control cube 10b.

The control cube 10b has four sides 40 to 43 in various shapes. Specifically, the sides 40, 41, 42 and 43 may have square, triangular, semicircular and rectangular shapes, respectively.

The control cube 10b is a polyhedron input interface device. The detector 21 of the tablet computer 10a can detect the shape of any of those four sides of the control cube 10a which is currently in contact with the touchscreen panel 11 of the capacitive type. The microcomputer 20 of the tablet computer 10a makes the tablet computer 10a change the kinds of operations to perform depending on what side has been detected. For that purpose, the control cube 10b has those four sides in mutually different shapes.

To allow the detector 21 of the tablet computer 10a to detect the shape of that side of the control cube 10b, at least the surface of the control cube 10b is made of a conductive material. Furthermore, the control cube 10b is made of a transparent material in order to prevent the control cube 10b being put on the touchscreen panel 11 from blocking the user's view of the image on the display panel 12. To satisfy these requirements, the control cube 10b has been formed by applying a transparent conductive powder of ITO (indium tin oxide) onto the surface of transparent polycarbonate.

If the range (or area) of a variation in electrostatic capacitance is less than a particular value, the detector 21 senses that the instruction has been entered with the stylus pen 10c. This means that depending on the density of arrangement of the electrodes, even if an instruction has been entered with the stylus pen 10c, the range of the variation in electrostatic capacitance could have a two-dimensional area, not a point. On the other hand, if the range (or area) of the variation in electrostatic capacitance is equal to or greater than the particular value, then the detector 21 makes out the shape of that area and determines which of those four sides 40 to 43 has the same shape as that area. As a result, the detector 21 can determine which of those four sides of the control cube 10b has been brought into contact with the touchscreen panel 11. To get this sensing operation done, information about the shapes and sizes of the respective sides of the control cube 10b should be stored in either the RAM 23 or storage 24 of the tablet computer 10a.

It should be noted that although a “cube” sometimes means a regular hexahedron, the control cube 10b of this embodiment is NOT a regular hexahedron as described above. Rather, those sides of the control cube 10b may even have polygonal or circular shapes and are supposed to have mutually different shapes. Optionally, some of those sides of the control cube 10b may be curved ones, too.

In the control cube of this embodiment, each edge which is formed between two sides that intersect with each other and each vertex which is an intersection between two edges are supposed to be angular ones in the following description. However, those edges or vertices do not have to be angular. Rather considering that the control cube is used as an input interface device, those edges and vertices may also be rounded in order to increase its holdability and the safety and to keep the touchscreen from getting scratched.

As described above, the tablet computer 10a changes its modes of operations or processing depending on what side of the control cube 10b is now in contact with the touchscreen panel 11 of the tablet computer 10a. Hereinafter, such an operation will be described in detail.

### 1. Touch Detecting Processing/Removal Detecting Processing

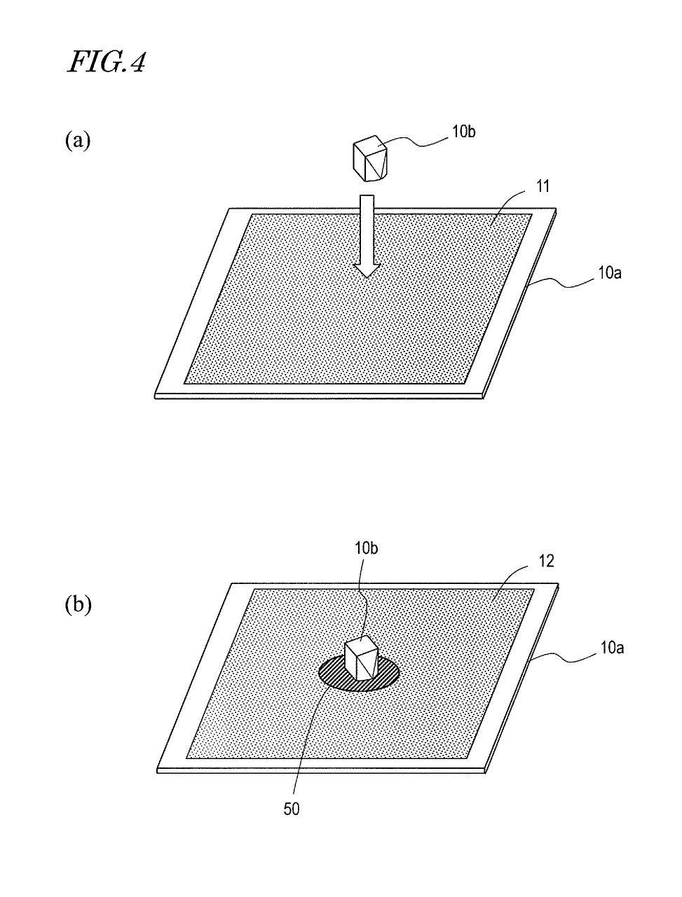

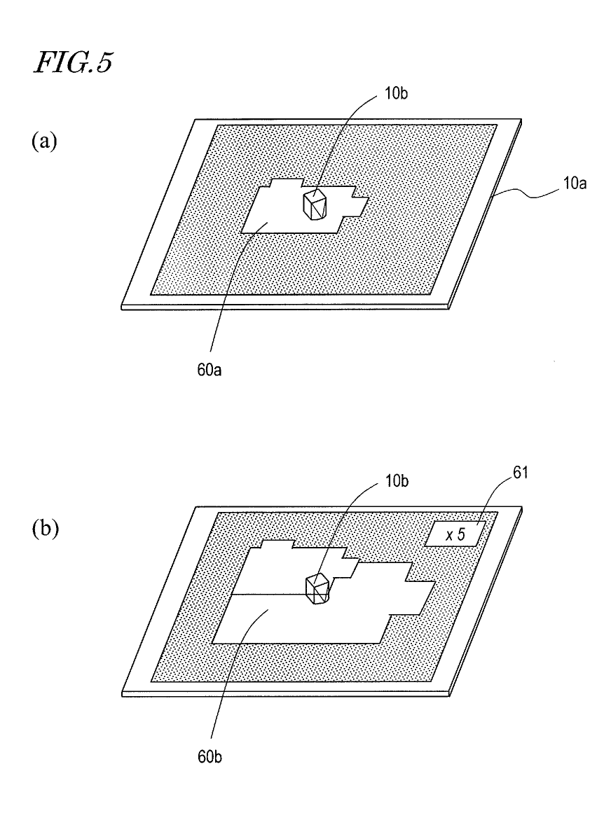

FIGS. 4(a) and 4(b) illustrate states before and after the control cube 10b is put on the touchscreen panel 11 of the tablet computer 10a by the user. The processing illustrated in FIG. 4 is display processing to be always carried out, no matter which side of the control cube 10b is currently in contact with the touchscreen panel 11. It will be described later how to change the modes of processing depending on which side of the control cube 10b is in contact with the touchscreen panel 11.

As shown in FIG. 4(a), the control cube 10b is brought closer to, and put on, the touchscreen panel 11. Then, the detector 21 of the tablet computer 10a recognizes the area in which the control cube 10b is put. In this description, that area will be sometimes regarded as a point macroscopically and sometimes referred to herein as a “touch point”. Then, the detector 21 transmits information about the location of the control cube 10b as a result of recognition to the microcomputer 20.

In response, the microcomputer 20 sends a control signal to the graphics controller 22 and instructs the graphics controller 22 to perform video effect display processing when the control cube 10b is recognized. In accordance with this instruction, the graphics controller 22 displays an easily sensible pattern in either the recognized area or a predetermined range which is defined with respect to the center of that area. For example, the graphics controller 22 may get a circular pattern 50, which is defined with respect to the center of that area, displayed by fade-in technique as shown in FIG. 4(b). This circular pattern 50 may be continuously displayed until the control cube 10b is removed from the surface of the touchscreen panel 11. It should be noted that the predetermined range does not have to be defined with respect to the center of that area. Anyway, by displaying a pattern at least in the vicinity of the touch point, the user can learn that the presence of the control cube 10b has been recognized.

When the control cube 10b is removed from the touchscreen, the detector 21 senses that the electrostatic capacitance that has been varying due to the contact with the control cube 10b has just recovered its reference level. And the detector 21 notifies the microcomputer 20 that the control cube 10b has been removed from the touchscreen.

In response to the notification, the microcomputer 20 sends a control signal to the graphics controller 22 and instructs the graphics controller 22 to perform the video effect display processing to be carried out when the control cube 10b is removed. In accordance with the instruction, the graphics controller 22 stops displaying that pattern 50 when a predetermined period of time (e.g., 0.5 seconds) passes. The pattern 50 may either be just erased or faded out. Alternatively, the pattern 50 may also be faded out after having been enlarged a little. Or the pattern 50 may be erased in any other arbitrary mode, too.

### 2. View changing processing

Next, the processing of zooming in on/out of, or moving, an image being displayed on the display panel 12 through a touch operation will be described. A mode of operation in which such processing is carried out will be referred to herein as a “view changing mode”. On sensing that the bottom 42 of the control cube 10b is in contact with the touchscreen panel 11, for example, the tablet computer 10a changes its modes of operation into the view changing mode. In other words, the bottom 42 of the control cube 10b is assigned the function of the viewing changing mode.

### 2.1 Image Zoom-in Processing to be Performed after Point of Contact has been Detected

FIG. 5(a) illustrates a situation where the pattern 50 has just been displayed after the detector 21 has sensed the contact of the control cube 10b with the touchscreen panel 11. It should be noted that the pattern 50 is not illustrated in FIG. 5(a) for convenience sake.

In the situation shown in FIG. 5(a), unless the detector detects any additional operation within a predetermined period of time (e.g., 0.5 seconds), the tablet computer 10a enters the view changing mode. In that mode, the microcomputer 20 instructs the graphics controller 22 to display a detailed image of an image object 60a which is currently displayed at the touch point of the control cube 10b. Optionally, when the image object 60a is changed into such a detailed image, the graphics controller 22 may add some visual effect as if the image displayed was zoomed in.

FIG. 5(b) illustrates the image object 60b which is now displayed as such a detailed image. Optionally, the zoom power may be determined in advance, and the graphics controller 22 may show the zoom power somewhere in the display area on the display panel 12. In the example illustrated in FIG. 5(b), a zoom power display zone 61 is provided at the upper right corner of the image. Alternatively, the zoom power may also be shown in the vicinity of the touch point of the control cube 10b.

Optionally, the graphics controller 22 may zoom in the image object 60a gradually with time. When the image object 60a is zoomed in or out, the zoom power with respect to the original image object 60a is shown (in the zoom power display zone 61, for example).

### 2.2 Zoom in/Out Processing Using Control Cube 10b and Stylus Pen 10c

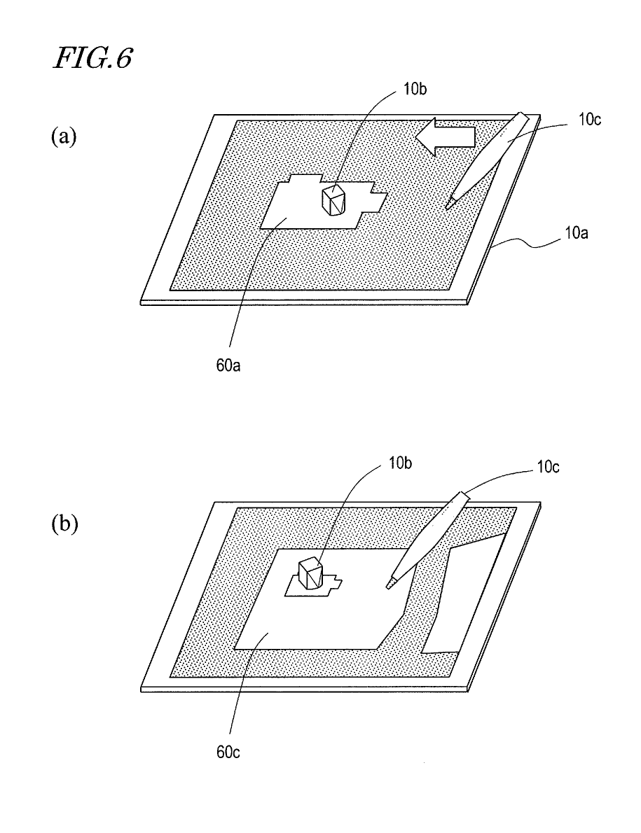

FIG. 6(a) illustrates a situation where the detector 21 has sensed that the stylus pen 10c has also contacted with the touchscreen panel while finding the control cube 10b still in contact with the touchscreen panel. When the user brings the stylus pen 10c into contact with the touchscreen panel, the tablet computer 10a changes its modes of operation into the view changing mode.

If the user widens or narrows the gap between the respective touch points of the control cube 10b and the stylus pen 10c, the microcomputer 20 instructs the graphics controller 22 to either zoom in or out the image being displayed. The graphics controller 22 zooms in or out the image by the zoom power to be determined by the gap that has been changed. Then, information about the zoom power is transmitted from the microcomputer 20 to the graphics controller 22.

For example, the user may drag the stylus pen 10c shown in FIG. 6(a) in the direction indicated by the arrow. FIG. 6(b) illustrates the image object 60c that has been zoomed out in response to that dragging. Although only the stylus pen 10c is supposed to have its touch point changed in this example, only the control cube 10b may have its touch point changed. Or both the stylus pen 10c and the control cube 10b may have their touch points changed at the same time. The zoom power may be determined depending on how much the relative locations of their touch points have changed. Optionally, the microcomputer 20 may also calculate the rate of widening their gap (i.e., the rate of change of their relative locations) and determine the zoom power based on the rate of change.

When the detector 21 senses that the user has brought the control cube 10b and/or the stylus pen 10c out of contact with the touchscreen, the view changing mode ends. The image object may be zoomed in or out up to a predetermined level. While the image object is being zoomed in or out, the zoom power with respect to the original one is shown. The graphics controller 22 may show the zoom power either in the zoom power display zone 61 shown in FIG. 5(b) or in the vicinity of the touch point of the control cube 10b, for example.

### 2.3. Rotation Processing Using Control Cube 10b and Stylus Pen 10c

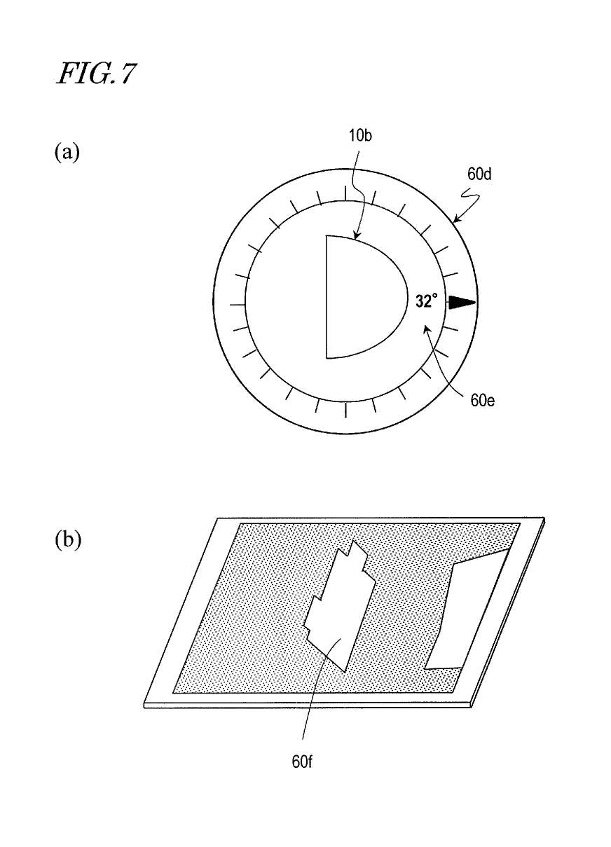

FIG. 7(a) illustrates an image 60d to be displayed in the vicinity of the touch point of the control cube 10b on the display panel 12 when the control cube 10b is rotated on the spot in the situation shown in FIG. 5(a). Also shown in FIG. 7(a) is the relative locations of the control cube 10b and the image 60d when the display panel 12 on which the control cube 10b is put is looked down from right over it.

First of all, in the situation shown in FIG. 5(a), the detector 21 senses that the control cube 10b has been rotated. In this description, “to rotate the control cube 10b” means that the user rotates the control cube 10b around an axis which intersects at right angles with the touchscreen panel 11. In this case, the location of the control cube 10b on the touchscreen panel 11 is substantially unchanged. By detecting continuously a variation in electrostatic capacitance, the detector 21 sequentially detects the shapes of the bottom 42 of the control cube 10b (see FIG. 3). As a result, the microcomputer 20 senses that the control cube 10b is rotating. In response, the microcomputer 20 instructs the graphics controller 22 to display an angle graduation image 60d indicating the angle of rotation and an image 60e indicating the angle that has been calculated with respect to the reference point shown in FIG. 5(a) around the touch point of the control cube 10b. These images 60d and 60e are displayed continuously while the control cube 10b is rotating. FIG. 7(a) illustrates how the control cube 10b shown in FIG. 5(a) is displayed after having been rotated counterclockwise by 32 degrees. Although no information indicating the counterclockwise direction is shown in FIG. 7(a), that information may be shown clearly by an arrow indicating the direction of rotation, for example.

While the control cube 10b is rotating, the microcomputer 20 instructs the graphics controller 22 to rotate the image 60a shown in FIG. 5(a).

FIG. 7(b) illustrates the image 60f which is displayed after having been rotated in the direction in which the control cube 10b has been rotated by an angle corresponding to the magnitude of dragging. It should be noted that illustration of the control cube 10b itself and the stylus pen 10c is omitted in FIG. 7(b).

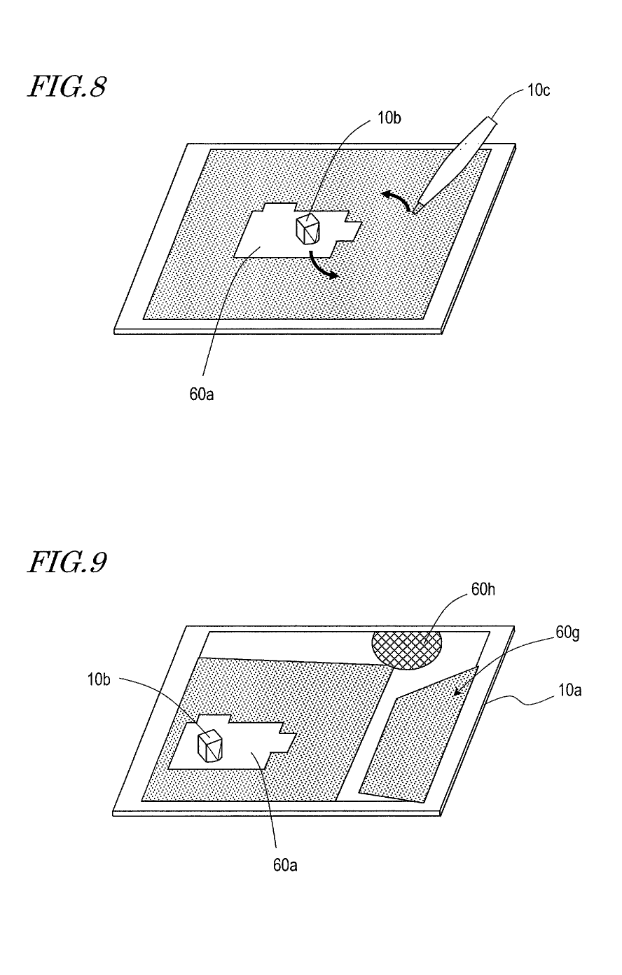

Optionally, a rotating operation may be performed using the control cube 10b and the stylus pen 10c. For example, as indicated by the arrows in FIG. 8, the control cube 10b and the stylus pen 10c may be dragged in the same direction of rotation so as to draw a circle while being kept in contact with the touchscreen panel 11. By detecting a change in a series of results of detection (coordinate data) gotten from the detector 21, the microcomputer 20 senses that the control cube 10b and the stylus pen 10c are being dragged while rotating. In response, the microcomputer 20 instructs the graphics controller 22 to rotate the image 60a shown in FIG. 5(a). As a result, the image 60f shown in FIG. 7(b) is also displayed after all.

### 2.4. Processing of Shifting Display Range by Dragging

FIG. 9 illustrates an image 60g to be displayed when the control cube 10b is further dragged on the touchscreen panel 11 in the situation shown in FIG. 5(a).

If the control cube 10b on the touchscreen panel 11 is dragged in a situation where only the control cube 10b is in contact with the touchscreen panel 11, the display range shifts according to the direction and magnitude of dragging. The detector 21 senses that the control cube 10b has been dragged toward the lower left corner on the paper from the location shown in FIG. 5(a). In response, the microcomputer 20 instructs the graphics controller 22 to shift the display range as shown in FIG. 9. As a result, the image object 60a originally displayed at the center is now located at the lower left corner and instead image objects 60g and 60h which have been hidden are now shown, for example.

### 3. Menu Display and Selection Processing

Next, a different kind of processing from the view changing processing which needs to be performed by brining a different side of the control cube 10b into contact with the touchscreen panel 11 will be described. In the following example, the rectangular side 43 of the control cube 10b that is its rear side is supposed to be brought into contact with the touchscreen panel 11.

### 3.1. Display of Menu Icons

When the side 43 of the control cube 10b (see FIG. 3(b)) contacts with the touchscreen panel 11, the detector 21 senses, by the shape of the area recognized, that the side 43 is now in contact with the touchscreen panel 11. Then, the tablet computer 10a changes the modes of operation into a menu display and selection processing mode. In other words, the side 43 of the control cube 10b has been assigned the function of the menu display and selection processing mode in advance.

When the modes of operation are changed into the menu display and selection processing mode, the microcomputer 20 instructs the graphics controller 22 to display a plurality of menu icons in the vicinity of the control cube 10b.

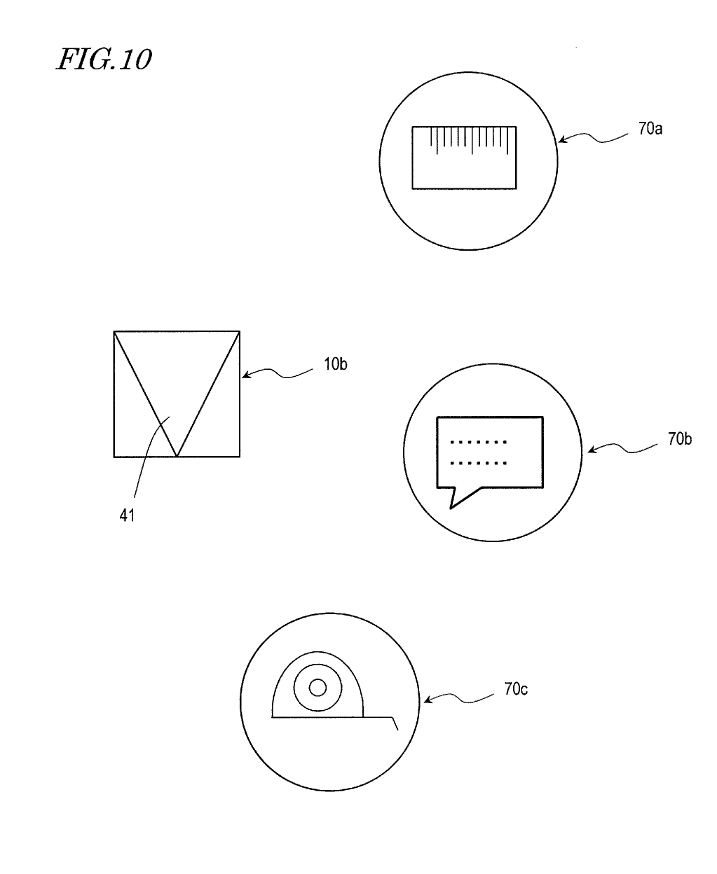

FIG. 10 illustrates multiple menu icons 70a to 70c displayed in the vicinity of the control cube 10b. Also shown in FIG. 10 is the control cube 10b. That is to say, what is shown in FIG. 10 is the relative locations of the control cube 10b and the menu icons 70a to 70c when the display panel 12 on which the control cube 10b is put is looked down from right over itself as in FIG. 7. Since the control cube 10b is put so that the side 43 is in contact with the touchscreen panel 11, the side 11 will face up when the control cube 10b is looked down from over itself.

The menu icon 70a represents a ruler mode in which an electronically displayed ruler is used. The menu icon 70b is a balloon insert mode in which a balloon is created by recognizing handwritten characters. And the menu icon 70c is a measure mode in which a length on a plan displayed is measured with a tape measure.

Hereinafter, it will be described what processing is carried out when each of these menu icons is selected. It should be noted that when any of these icons is selected, the microcomputer 20 instructs the graphics controller 22 to erase the menu icons 70a to 70c shown in FIG. 10 and display the image to be described below instead.

### 3.2. Processing to be Carried Out when Ruler Mode is Selected

When the user taps, with the stylus pen 10c, a screen area where the menu icon 70a representing a ruler is displayed, the detector 21 senses that the stylus pen 10c has contacted with that area. Then, the decision is made by the microcomputer 20 that the menu icon displayed in that area has been selected. As a result, the tablet computer 10a enters the ruler mode corresponding to that menu icon.

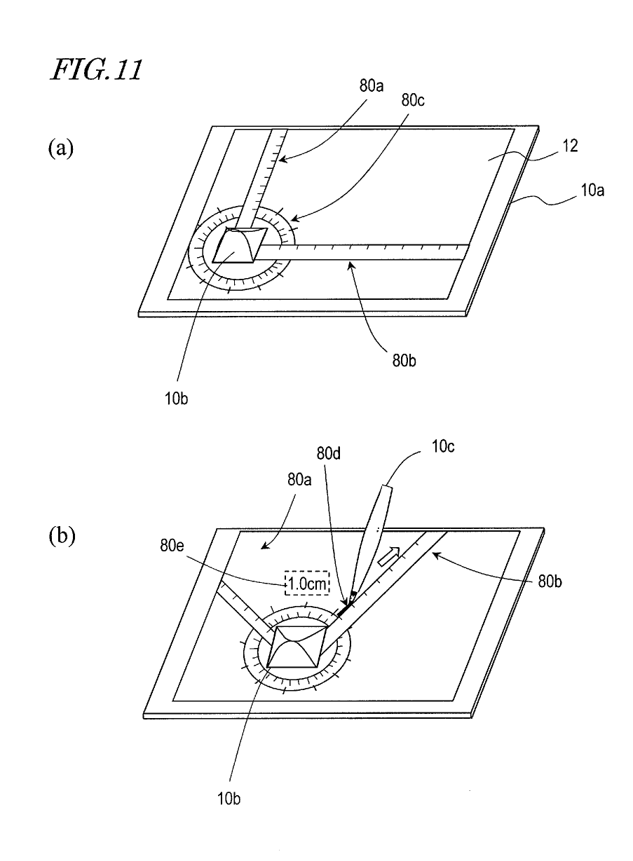

FIG. 11(a) illustrates what image objects may be displayed at an initial stage of the ruler mode. In accordance with the instruction given by the microcomputer 20, the graphics controller 22 displays image objects 80a and 80b representing rulers (which will be referred to herein as “ruler image objects 80a and 80b”) and an image object 800 representing a goniometer (which will be referred to herein as a “goniometer image object 80c”) that indicates the angle of rotation on the display panel 12 as shown in FIG. 11(a).

The ruler image objects 80a and 80b have graduations. The graphics controller 22 adjusts the graduation interval according to the current zoom power of the images on the screen. Initially, these ruler image objects 80a and 80b are displayed parallel to the vertical and horizontal sides of the display panel 12 with the touch point defined as the vertex angle.

The other goniometer image object 80c has multiple sets of gradations and uses, as a reference, what is displayed on the screen initially. For example, the longer graduation interval may be 30 degrees and the shorter graduation interval may be 10 degrees.

If the user rotates the control cube 10b around an axis which intersects at right angles with the touchscreen panel 11 while only the control cube 10b is in contact with the touchscreen panel 11, the ruler image objects 80a and 80b rotate to the same degree in the same direction of rotation. As a result, these ruler image objects 80a and 80b become no longer parallel to the vertical and horizontal sides of the touchscreen. These ruler image objects 80a and 80b that have been rotated to a predetermined degree are shown in FIG. 11(b), for example. In this case, if the user drags the control cube 10b, the graphics controller 22 translates the ruler image objects 80a and 80b.

While these image objects 80a and 80b are rotating, another image object (not shown) indicating the magnitude of rotation from their initial display locations by using the angles at those locations as a reference may be displayed around the axis of rotation as in the example illustrated in FIG. 7(a).

Optionally, a linear image object may be added to the image displayed on the display panel 12 by using the ruler image objects 80a and 80b. For example, FIG. 11(b) illustrates an example in which a linear image object 80d is added using the stylus pen 10c and the ruler image object 80b. The user puts the stylus pen 10c in the vicinity of the ruler image object 80b and then drags the stylus pen 10c along the image object 80b. In response, the detector 21 senses that the stylus pen 10c has contacted with the touchscreen panel 11 and that the point of contact has changed as a result of dragging that has been done after that. Based on these results of detection, the microcomputer 20 senses that dragging is being performed with the stylus pen 10c and instructs the graphics controller 22 to perform the processing of adding a line. In accordance with this instruction, the graphics controller 22 draws a linear object 80d, of which the length is defined by the drag length, from the first touch point of the stylus pen 10c in the dragging direction so that the linear object 80d is superimposed on the image being displayed on the display panel 12. Meanwhile, a piece of information 80e indicating the length of the line that has been drawn is displayed in the vicinity of the touch point of the stylus.

When the control cube 10b and the stylus pen 10c are removed from the touchscreen, editing of the image object 80d representing such a line drawn is entered and the ruler mode ends.

### 3.3. Processing to be Carried Out when Balloon Insert Mode is Selected

Next, the balloon insert mode will be described with reference to FIG. 10 again.

When the user taps, with the stylus pen 10c, a screen area where the menu icon 70b representing a balloon is displayed, the detector 21 senses that the stylus pen 10c has contacted with that area. Then, the decision is made by the microcomputer 20 that the menu icon displayed in that area has been selected. As a result, the tablet computer 10a enters the balloon insert mode corresponding to that menu icon.

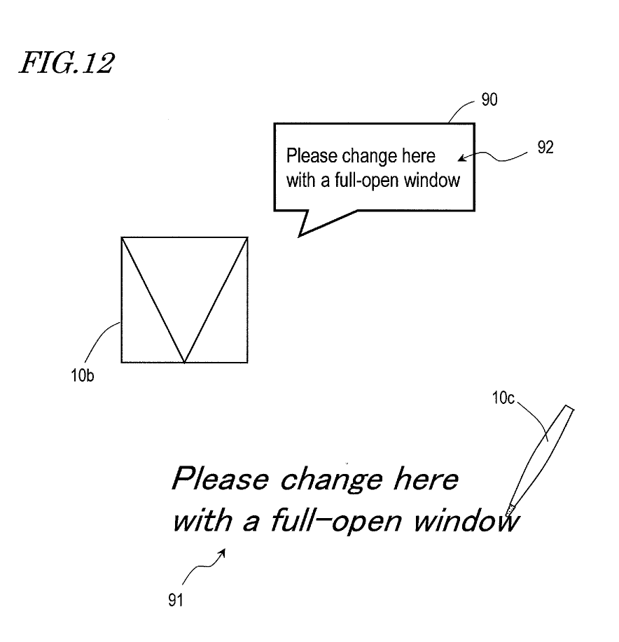

FIG. 12 illustrates an exemplary image object to be displayed when the balloon insert mode is entered. The microcomputer 20 waits for the user to enter handwritten characters with the stylus pen 10c. On sensing that handwritten characters have been entered with the stylus pen 10c, the detector 21 transmits the handwriting data detected to the microcomputer 20. Either a conversion rule for converting handwriting data into characters or text data to be used after the conversion is stored in advance in the RAM 23 or the storage 24 of the tablet computer 10a. By reference to that conversion rule, the microcomputer 20 recognizes the characters entered based on the handwriting data gotten and provides the character information for the graphics controller 22. In response, the graphics controller 22 reads text data corresponding to those characters and then displays a text, represented by that data, as a balloon image object 90. FIG. 12 illustrates an image 91 representing handwritten characters and a text 92 displayed in the balloon image object 90. It should be noted that while handwritten characters are being entered, the control cube 10b stays put on the touchscreen panel 11.

When the control cube 10b and the stylus pen 10c are removed from the touchscreen, editing of the image object 90 representing such a balloon drawn is entered and a balloon including a message is fixed in the vicinity of the control cube 10b. However, depending on the length of the message, not the entire message will be displayed. For example, if the user taps that balloon with the stylus pen 10c, the graphics controller 22 may display the entire message.

### 3.4. Processing to be Carried Out when Measure Mode is Selected

Next, the measure mode will be described with reference to FIG. 10 again.

When the user taps, with the stylus pen 10c, a screen area where the menu icon 70c representing a tape measure is displayed, the detector 21 senses that the stylus pen 10c has contacted with that area. Then, the decision is made by the microcomputer 20 that the menu icon displayed in that area has been selected. As a result, the tablet computer 10a enters the measure mode corresponding to that menu icon.

The measure mode is a mode indicating the length of a line segment that starts at a point where the screen was tapped for the first time with the stylus pen 100 and that ends at a point where the screen was tapped for the second time with the stylus pen 10c. The detector 21 transmits two pieces of information about those two points where the screen was tapped for the first time and for the second time to the microcomputer 20. In response, the microcomputer 20 calculates the distance between those two points on the image (e.g., the distance between two pixels) and then calculates the distance on the plan based on the current zoom power. As a result, the distance between any two points on the image currently displayed on the display panel 12 can be obtained.

In the foregoing description, menu icons are supposed to be displayed when the rear side 43 of the control cube 10b is brought into contact with the touchscreen panel 11. However, this processing is only an example of the present disclosure. Even if such menu icons are not displayed, functions to activate such a mode that allows the user to use a ruler or enter handwritten characters may be allocated to respective sides of the control cube 10b.

### 4. Dual View Mode Processing

The dual view mode is a display mode to be activated with two users seated on two opposing sides (e.g., at the two shorter sides) of a tablet computer to face each other. In this case, one of the two users is a person who operates the machine to control the display of an image (and who will be referred to herein as an “operator”), while the other user is a person who browses the image displayed (and who will be referred to herein as a “browser”). An operation to be performed in such a dual view mode will be referred to herein as “dual view mode processing”.

When the touchscreen panel 11 is tapped with the side 40 (see FIG. 3) of the control cube 10b, for example, the tablet computer 10a enters the dual view mode. Alternatively, the tablet computer 10a may also change its modes of operation into the dual view mode when a dual view mode enter button displayed (as an image object) on the screen is tapped, for example. Still alternatively, the tablet computer 10a may also change its modes of operation into the dual view mode when lifted so that one of its shorter sides faces down. In the latter example, such an operation is detected by an acceleration sensor (not shown) built in the tablet computer.

In the dual view mode, the contents of the video viewed and listened to by the operator and the contents of the video viewed and listened to by the browser have been inverted 180 degrees with respect to each other. In the following example, it will be described how to present a virtual tour of a building on the screen.

FIG. 13 illustrates exemplary video to be displayed in the dual view mode.

A plan is displayed in a first area 110, in which numerals indicating the dimensions of the plan and characters indicating a room name in the building are displayed in the right direction for the operator (i.e., displayed in a normal direction in which the operator can read them easily). That is to say, this plan is displayed wrong side up for the browser.

On the other hand, in the example illustrated in FIG. 13, the video (movie) of the virtual tour to be viewed and listened to by the browser is shown in a second area 120 closer to the browser. Presentation of the movie is controlled in response to an operation by the operator. This movie is displayed in the right direction for the browser (specifically, so that the floor of the building in the video is shown at the bottom and the ceiling of the building is shown at the top).

If the operator puts the side 40 of the control cube 10b (see FIG. 3) on the image being displayed on the display panel 12 while the virtual tour is being presented, the plan is zoomed in at a predetermined zoom power and displayed on the screen. For example, suppose the operator has put the control cube 10b at a point on a passage on the plan. Then, a zoomed-in image of that point is displayed. In the example illustrated in FIG. 13, a zoomed-in plan is displayed in the first area 110.

When the control cube 10b is put on the image, first of all, the microcomputer 20 determines exactly where on the plan displayed the control cube 10b is currently located. And the microcomputer 20 instructs the graphics controller 22 to output three-dimensional video representing that location. Thereafter, when the operator shifts the control cube 10b along the passage displayed, the detector 21 senses that the control cube 10b has changed its location. That information is sent to the microcomputer 20, which detects the direction, magnitude and velocity of the movement. Then the microcomputer instructs the graphics controller 22 to display, in the second area 120, three-dimensional video that will make the browser feel as if he or she were moving inside the building in that direction and at that velocity. The direction, magnitude and velocity of movement in the three-dimensional video change according to the direction, magnitude and velocity of shift of the control cube 10b. As a result, the browser can experience a virtual tour of a building which is still in the stage of planning.

In the foregoing description of embodiments, the control cube 10b has been described as an exemplary polyhedron input interface device with multiple sides that have mutually different shapes. Hereinafter, some modified examples of the input interface device will be described.

### Modified Example 1

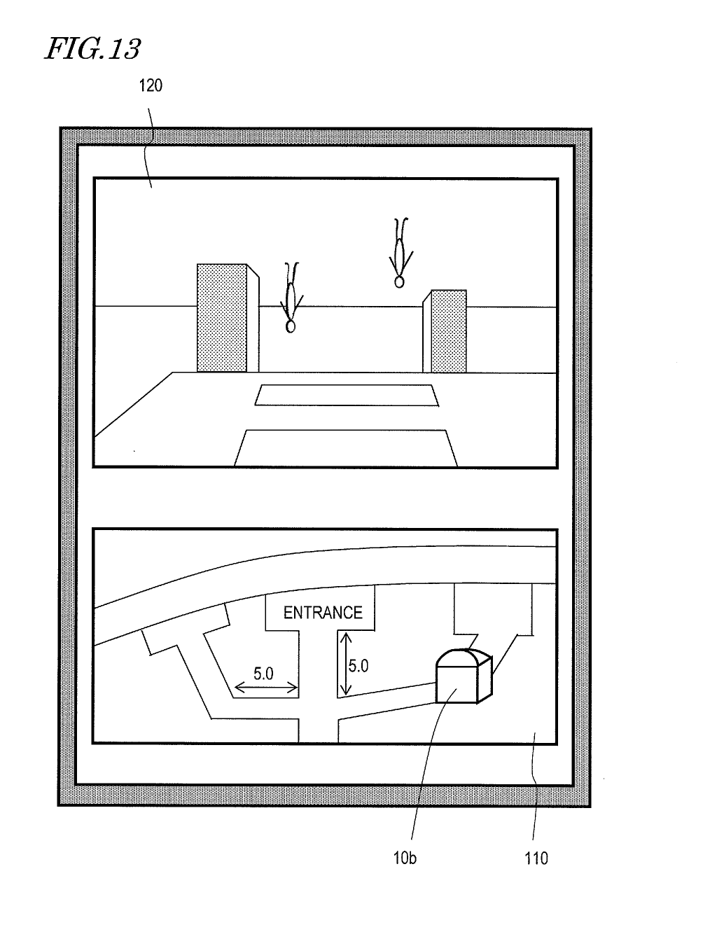

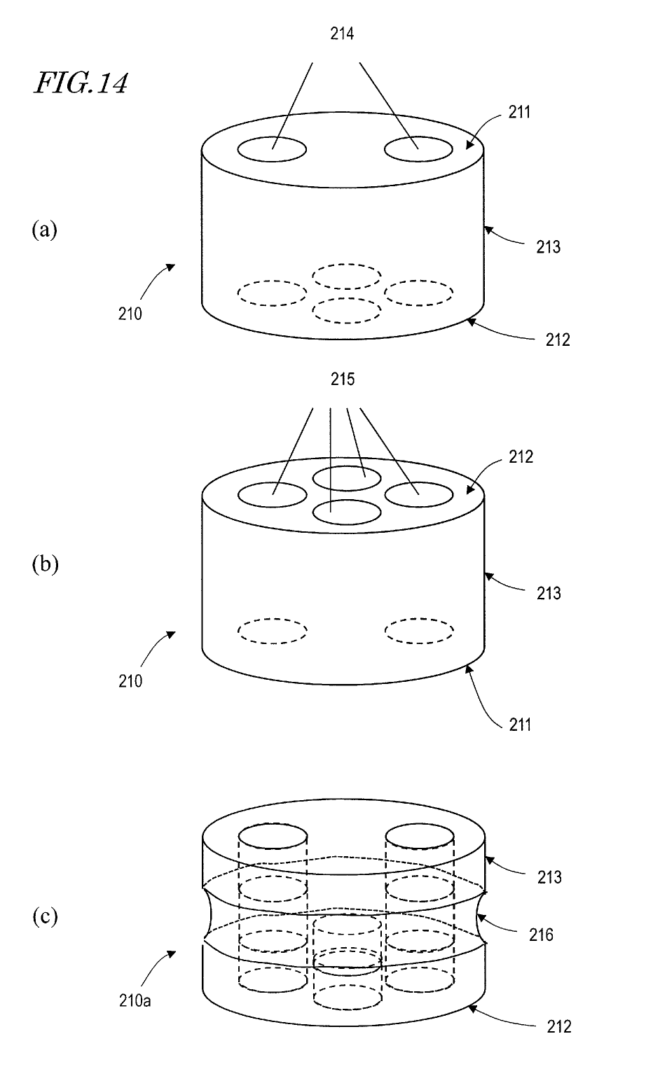

FIGS. 14(a) and 14(b) illustrate the appearance of a control cylinder 210, which is an input interface device for operating the tablet computer 10a of the information processing system 100 (see FIG. 1) by performing a touch operation on the tablet computer 10a. The control cylinder 210 may form part of the information processing system 100 either in place of, or along with, the control cube 10b. Optionally, the stylus pen 10c may also be used along with the control cylinder 210 as an additional input interface device. The same can be said about Modified Examples 2 to 6 to be described later.

As shown in FIGS. 14(a) and 14(b), the control cylinder 210 has a circular cylindrical shape. The control cylinder 210 has two sides 211 and 212 and a side surface 213. FIGS. 14(a) and 14(b) illustrate the appearance of the control cylinder 210 which is arranged with its side 211 faced up and its side 212 faced up, respectively. The control cylinder 210 may be made of a transparent resin, for example.

As shown in FIG. 14(a), the side 211 has two terminals 214. On the other hand, as shown in FIG. 14(b), the side 212 has four terminals 215. Each of those two terminals 214 and each of those four terminals 215 are made of such a material, or have such a structure, that makes the terminal detectible by the touchscreen panel 11. For example, if the touchscreen panel 11 adopts the capacitive method, each of those terminals is made of a conductive material. More specifically, in that case, each terminal may be made of a metallic fiber with conductivity, conductive silicone rubber, or a conductor such as copper or aluminum. Optionally, an electrode may be formed on the side 211 or 212 by coating the side 211 or 212 with a transparent conductive powder of ITO (indium tin oxide).

Suppose the control cylinder 210 has been put on the capacitive touchscreen panel 11 of the tablet computer 10a. In that case, the detector 21 of the tablet computer 10a detects a variation in electrostatic capacitance, thereby determining how many terminals the control cylinder 210 being in contact with the touchscreen panel 11 has. By reference to information about a point of touch made by the user which has been provided by the detector 21, the microcomputer 20 of the tablet computer 10a can determine which of these two sides 211 and 212 is in contact with the touchscreen panel 11. In the exemplary arrangement shown in FIG. 14(a), the side 212 is in contact with the touchscreen panel 11. On the other hand, in the exemplary arrangement shown in FIG. 14(b), the side 211 is in contact with the touchscreen panel 11. Depending on which side has turned out to be in contact with the touchscreen panel 11, the microcomputer 20 of the tablet computer 10a makes the tablet computer 10a perform a different kind of operation. For these purposes, the control cylinder 210 has a plurality of sides which have respectively different numbers of terminals from each other.

In the foregoing description, the detector 21 is supposed to determine the number of terminals and the microcomputer 20 is supposed to determine which side is in contact with the touchscreen panel 11 now. However, these operations are just an example. Rather, it is not always necessary to determine which of the two sides 211 and 212 is in contact with the touchscreen panel 11 but the number of terminals that are in contact with the touchscreen panel 11 just needs to be determined. That is to say, the tablet computer 10a has only to change the modes of operation or processing according to the number of terminals detected. In this case, examples of those modes of operation or processing include the touch/removal detecting processing, the view changing processing, the menu display and selection processing and the dual view mode processing.

If terminal information which can be used to find the shape and size of each of those terminals is provided in advance, the microcomputer 20 can easily detect the terminal. In this example, every terminal is supposed to have the same shape and same size (e.g., have a circular plate shape with a diameter of 1 cm). The terminal information is stored in either the RAM 23 or the storage 24 of the tablet computer 10a. In the following description, the areas of contact with the touchscreen panel 11 are supposed to increase in the order of the tip of the stylus pen 10c, the terminals and the sides of the control cube 10b.

If a variation range (or area) of the electrostatic capacitance is equal to or smaller than a first threshold value, the detector 21 senses that the tip of the stylus pen 15 is in contact with that variation range. On the other hand, if the variation range (or area) of the electrostatic capacitance is greater than the first threshold value but equal to or smaller than a second threshold value, the detector 21 senses that one of the terminals is in contact with that variation range. And if the variation range (or area) of the electrostatic capacitance is greater than the second threshold value but equal to or smaller than a third threshold value, the detector 21 senses that one of the sides of the control cube 10b is in contact with that variation range. As a result, the detector 21 can determine how many terminals of the control cylinder 210 have contacted with the touchscreen panel 11.

Optionally, by reference to information about the locations where the respective terminals have been detected as complementary information, the tablet computer 10a may determine whether the two terminals 214 or the four terminals 215 are currently in contact with the touchscreen panel 11. In this case, the information about the locations where the respective terminals have been detected may be information about the cross arrangement of the four terminals in the exemplary arrangement shown in FIG. 14(a) and information about the linear arrangement of the two terminals in the exemplary arrangement shown in FIG. 14(b). The larger the number of terminals, the more significantly the accuracy of decision can be increased by performing pattern matching processing on the detected pattern of the group of terminals and a predefined pattern. Or if one or multiple terminals have failed to be detected for some reason, the detector 21 can estimate the number of terminals by reference to the detected pattern of the group of terminals and the predefined pattern.

In the example described above, the sides 211 and 212 of the control cylinder 210 are supposed to be perfect circles. However, those sides 211 and 212 do not have to be perfect circles but may have any other arbitrary shape. Rather, as long as the number of terminals provided for one side is different from that of terminals provided for the other, the tablet computer 10a can tell each of these two sides from the other. As long as those two sides have mutually different numbers of terminals, those two sides may have any arbitrary shapes. Thus, the sides 211 and 212 may even have elliptical, square or rectangular shapes as well.

Furthermore, even if the two sides have the same number of terminals, those terminals may be arranged in different patterns on the two sides. For example, suppose a situation where four terminals are arranged in a cross pattern on each of the two sides but where the interval between those four terminals arranged on one side is different from the interval between those four terminals arranged on the other. In that case, the tablet computer 10a can recognize one group of four terminals that are arranged at relatively narrow intervals and the other group of terminals that are arranged at relatively wide intervals as two different groups of terminals.

In another example, the tablet computer 10a can also recognize a group of four terminals that are arranged in a cross pattern on one side and another group of four terminals that are arranged along the circumference of a semicircle on the other side as two different groups of terminals, too.

As can be seen from the foregoing description, either the number or arrangement of terminals are different to a sensible degree between multiple sides of the input interface device. By sensing the difference in the number or arrangement of terminals between those sides, the tablet computer 10a can perform a different kind of operation based on the result of sensing.

Furthermore, in FIGS. 14(a) and 14(b), each of the two terminals 214 and each of the four terminals 215 are drawn as having a planar shape on the sides 211 and 212, respectively. However, this is also just an example and those terminals 214 and 215 may have any other arbitrary shapes, too.

For example, each of the two terminals 214 and each of the four terminals 215 may be electrically connected to the other(s) inside the control cylinder. FIG. 14(c) illustrates a control cylinder 210a with a conductive structure 216 which is similar to the conductive structure to be described later. The conductive structure 216 is made of a conductive material and the two terminals 214 are electrically connected together inside the control cylinder 210a, so are the four terminals 215. An embodiment like this also falls within the range of the present disclosure.

### Modified Example 2

In Modified Examples 2 through 6 to be described below, input interface devices, each having a sensor for detecting its own orientation, will be described. In the following description, any pair of components having substantially the same function or structure will be identified by the same reference numeral. And once such a component has been described, description of its counterpart will be omitted herein to avoid redundancies.

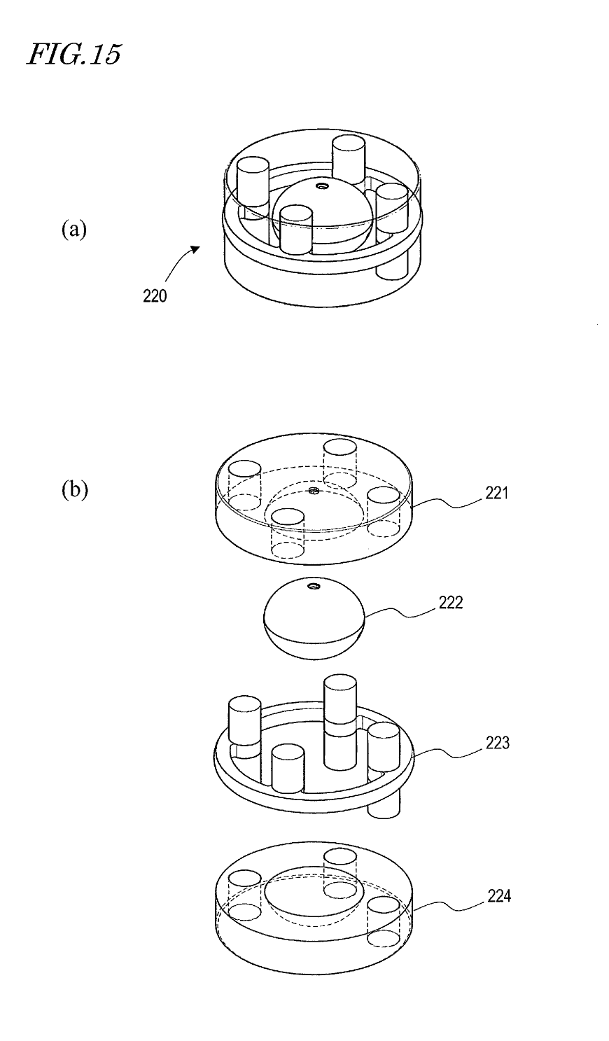

FIG. 15(a) is a perspective view illustrating a control cylinder 220 as Modified Example 2 and FIG. 15(b) is an exploded view thereof.

As shown in FIG. 15(b), the control cylinder 220 includes a housing part 221, an orientation detecting module 222, a conductive structure 223, and another housing part 224.

The housing parts 221 and 224 may be molded parts of transparent non-conductive resin, for example. Each of these housing parts 221 and 224 has depressions and through holes to which the orientation detecting module 22 and conductive structure 223 to be described later are to be fitted. These housing parts 221 and 224 have mutually different numbers of through holes to which the conductive structure 23 is fitted.

The orientation detecting module 222 is fitted into the housing parts 221 and 224 to detect any change in the orientation of the control cylinder 220. The orientation detecting module 222 transmits information about the detected orientation wirelessly to the tablet computer 10a. In this modified example, the orientation detecting module 222 has a spherical shape.

FIG. 16 illustrates a hardware configuration for the orientation detecting module 222, which includes a microcomputer 222a, a sensor 222b, an A/D converter (ADC) 222c, a transmitter 222d, and a bus 222e that connects these components together so that they can communicate with each other. Although not shown in FIG. 16, the orientation detecting module 222 further has a battery which supplies power to operate these components.

The microcomputer 222a controls the start and end of the operation of the entire orientation detecting module 222.

The sensor 222b may include a built-in triaxial angular velocity sensor (i.e., a gyrosensor) and a built-in triaxial acceleration sensor, and detects the movement of the orientation detecting module 222 along six axes overall. When the orientation detecting module 222 is fitted into the housing parts 221 and 224, the sensor 222b can detect the movement of the control cylinder 220. It should be noted that known sensors may be used as the triaxial angular velocity sensor (gyrosensor) and triaxial acceleration sensor. Alternatively, the sensor 222b may include an electronic compass as well. An electronic compass can also be said to be a sensor which senses any change in the orientation of the control cylinder 220. The electronic compass may be provided as an additional member for the triaxial angular velocity sensor (gyrosensor) and triaxial acceleration sensor, or in combination of any of these two kinds of sensors, or even by itself.

The ADC 222c converts the analog signal supplied from those axial sensors into digital signals.

The transmitter 222d outputs the digital signals by carrying out radio frequency communications compliant with the Wi-Fi standard or the Bluetooth standard, for example. These digital signals will be received by the communications circuit 25 of the tablet computer 10a (see FIG. 2).

Next, the conductive structure 223 will be described with reference to FIG. 15(b) again. The conductive structure 223 is made of a conductive material. When fitted into the housing parts 221 and 224, the conductive structure 223 will be partially exposed. More specifically, the conductive structure 223 will be exposed in the circumferential direction on the side surface of the control cylinder 220. In addition, the conductive structure 223 will also be exposed at four points on one side of the control cylinder 220 and at three points on the other side. Those exposed portions of the conductive structure 223 function just like the terminals of the control cylinder 210 described above.

Suppose the control cylinder 220 has been put on the capacitive touchscreen panel 11 of the tablet computer 10a. In that case, the detector 21 of the tablet computer 10a also detects a variation in electrostatic capacitance as in Modified Example 1 described above. As a result, the detector 21 or the microcomputer 20 can detect the number of terminals of the control cylinder 220 which are in contact with the touchscreen panel 11.

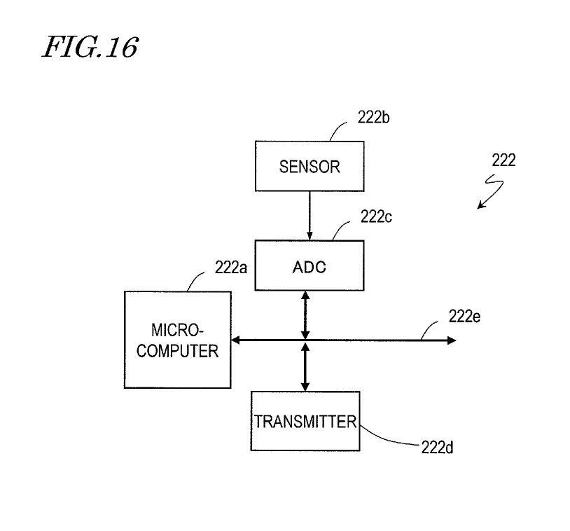

FIGS. 17(a) and 17(b) are perspective views respectively illustrating the top and bottom of a conductive structure 223 according to Modified Example 2, and FIG. 17(c) is an exploded view thereof. As shown in FIG. 17(c), the conductive structure 223 of this modified example can be broken down into four legs 223a, a frame 223b and three more legs 223c. However, this is just an exemplary configuration. Optionally, part or all of these members may be molded together.

By using the wireless communication ability of the control cylinder 220, the user can operate the tablet computer 10a by another novel method. That is to say, since information about any change in orientation caused by his or her operation can be transmitted wirelessly to the tablet computer 10a, the user can operate the tablet computer 10a without putting his or her fingers on the tablet computer 10a.

For example, suppose while a plan of a building is being displayed on the tablet computer 10a, the user shifts the control cylinder 220 parallel to the touchscreen panel 11 without putting his or her fingers on the touchscreen panel 11. Then, the orientation detecting module 222 detects the acceleration in the shifting direction. The tablet computer 10a gets that information from the control cylinder 220 and calculates the velocity and the distance traveled. More specifically, the microcomputer 20 of the tablet computer 10a calculates the temporal integral of the acceleration as the velocity and then calculates the temporal integral of the velocity as the distance traveled. The microcomputer 20 performs the same operation as in a situation where the control cube 10b has been dragged on the touchscreen panel 11 as shown in FIG. 9 at shift velocity (i.e., direction and velocity of shift) and distance corresponding to that velocity and the distance traveled.

As another example, suppose a 3D image object of a building is being displayed on the display panel 12 of the tablet computer 10a. If the user lifts, holds still and then rotates the control cylinder 220, then the orientation detecting module 222 detects the direction of that rotation and the angular velocity. The tablet computer 110a gets those pieces of information from the control cylinder 220 and the microcomputer 20 rotates the 3D image object of the building being displayed in the direction of rotation corresponding to that direction of rotation and at the angular velocity corresponding to that angular velocity. Optionally, by translating the control cylinder 220 while rotating it, that image object can be further translated.

In rotating or translating the image object, location information (coordinates) of the vertices that form the image object needs to be transformed using a predetermined coordinate transformation matrix. Examples of known matrices for use to carry out the coordinate transformation include a transfer matrix, a rotation matrix and a projection matrix. A known matrix may also be used to perform that operation.

### Modified Example 3

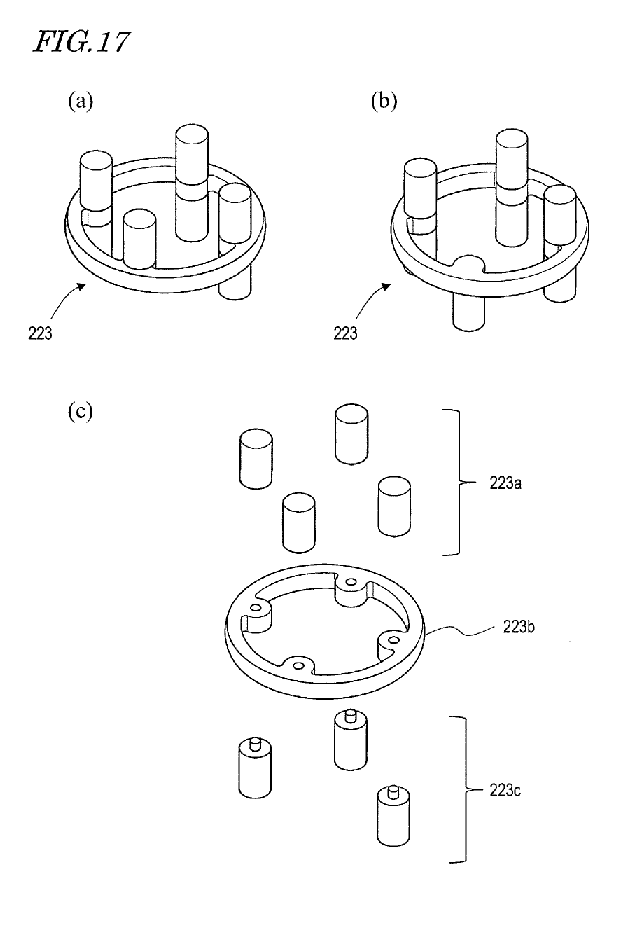

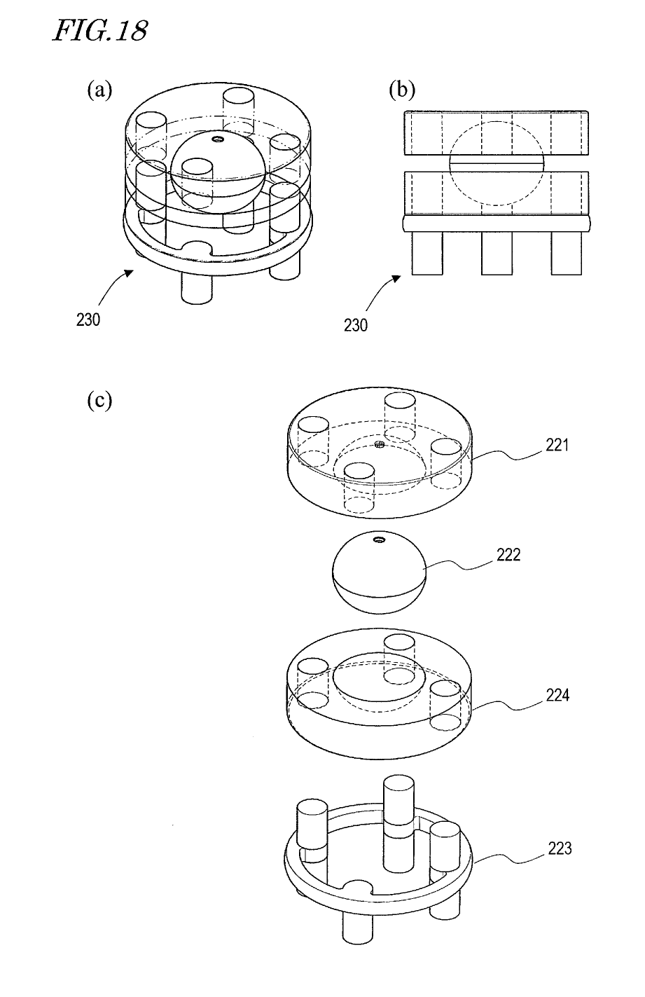

FIGS. 18(a), 18(b) and 18(c) are respectively a perspective view, a side view and an exploded view of a control cylinder 230 as Modified Example 3.

In this control cylinder 230, the conductive structure 223 and the housing part 224 are assembled together in a different order from the control cylinder 220 of Modified Example 2 (see FIG. 15). In this control cylinder 230, the four leg portions 223a and frame 223b of the conductive structure 223 are exposed.

The rest of the configuration and the operation of the tablet computer 10a using the control cylinder 230 are the same as in Modified Example 2, and description thereof will be omitted herein.

### Modified Example 4

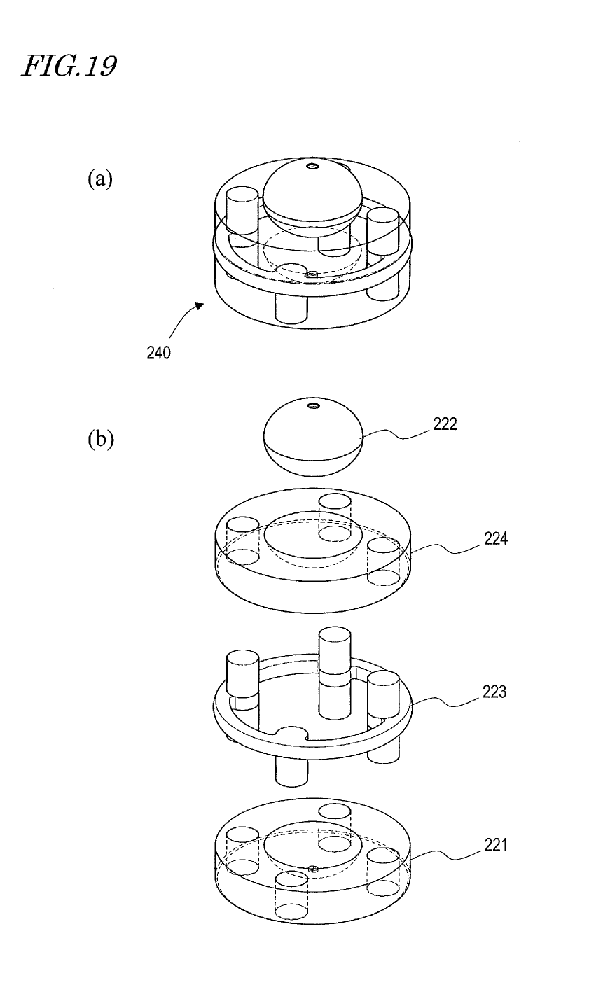

FIGS. 19(a) and 19(b) are respectively a perspective view and an exploded view of a control cylinder 240 according to Modified Example 4.

In this control cylinder 240, the orientation detecting module 222 is not fitted into the housing part 221 but exposed and the conductive structure 223 is fitted into the housing part 221 unlike the control cylinder 230 of Modified Example 3 (see FIG. 18). Since the spherical orientation detecting module 222 is exposed, the control cylinder 240 of this modified example allows the user to rotate the orientation detecting module 222 just like a trackball. As a result, the tablet computer 10a can rotate the image object displayed.

The rest of the configuration and the operation of the tablet computer 10a using the control cylinder 230 are the same as in Modified Example 2, and description thereof will be omitted herein.

### Modified Example 5

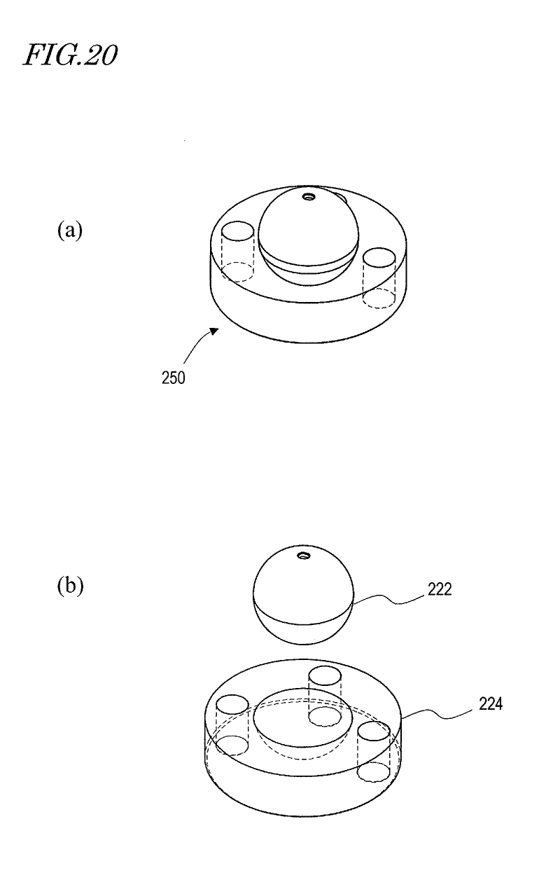

FIGS. 20(a) and 20(b) are respectively a perspective view and an exploded view of a control cylinder 250 according to Modified Example 5.

This control cylinder 250 is comprised of only the orientation detecting module 222 and the housing part 224, which is quite different from the control cylinder 230 of Modified Example 4 (see FIG. 19). The control cylinder 250 of this modified example includes neither the housing part 221 nor the conductive structure 223 of the control cylinder 230 of Modified Example 4 (see FIG. 19).

As in Modified Example 4 described above, the control cylinder 250 of this modified example also allows the user to rotate the image object displayed on the tablet computer 10a by rotating the orientation detecting module 222 just like a trackball.

The control cylinder 250 of this modified example includes no conductive structure 223, and therefore, causes no variation in electrostatic capacitance in the touchscreen panel 11. However, since the control cylinder 250 can be operated while being mounted stably on the touchscreen panel 11, this modified example can be used effectively in a situation where a precise operation needs to be done.

### Modified Example 6

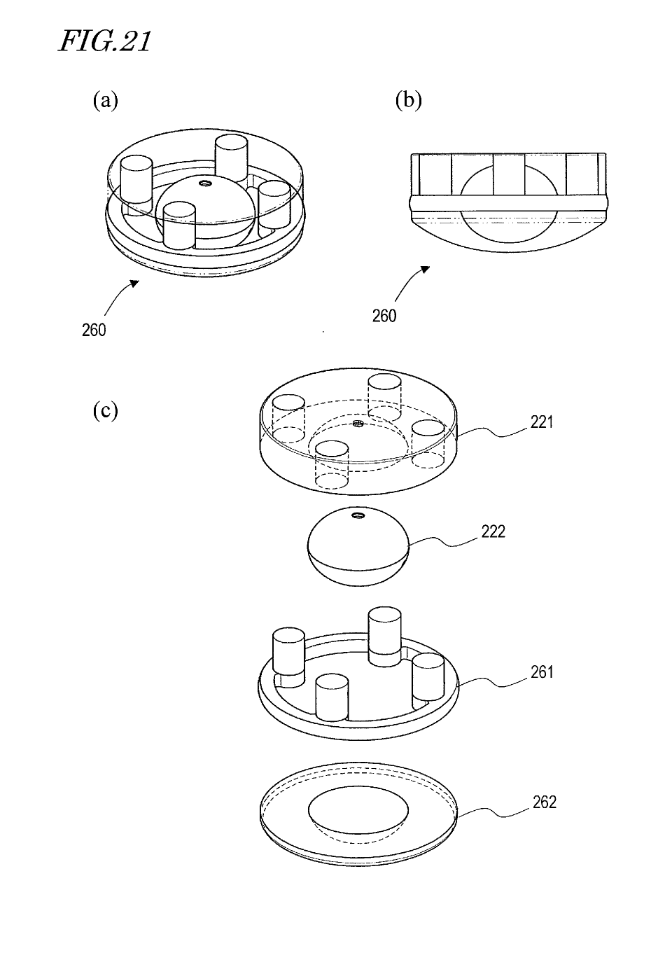

FIGS. 21(a), 21(b) and 21(c) are respectively a perspective view, a side view and an exploded view of a control cylinder 260 as Modified Example 6.

The control cylinder 260 of this modified example includes a conductive structure 261 and a housing part 262 in place of the conductive structure 223 and housing part 224 of the control cylinder 220 shown in FIG. 15. As shown in FIG. 21(b), the surface of the housing part 262 opposite from the surface to support the orientation detecting module 222 to be fitted is a gently curved surface. With such a curved surface provided, the angle of rotation can be finely adjusted easily when a 3D image object needs to be displayed with its angle finely adjusted. The housing part 221 has through holes to partially expose the conductive structure 261. That is why if this control cylinder 260 is put upside down, a variation can be caused in the electrostatic capacitance of the touchscreen panel 11.

In Modified Examples 2 to 6 described above, the orientation detecting module 222 is supposed to be provided for the control cylinder. However, the orientation detecting module 222 may also be provided inside the control cube 10b that has been described for the first embodiment.

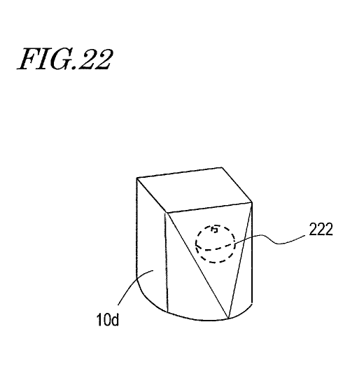

FIG. 22 illustrates a control cube 10d including the orientation detecting module 222. This control cube 10d may be used instead of the control cube 10b shown in FIG. 1. The orientation detecting module 222 inside the control cube 10b detects and outputs a signal representing the orientation. And the communications circuit 25 of the tablet computer 10a receives that signal. As a result, the tablet computer 10a can change a mode of the image object being displayed by moving or rotating the image object in response to a user's operation that has been performed using such a control cube 10b.

The present disclosure is applicable to any information processing apparatus which includes a touchscreen panel and a display panel and which allows the user to enter his or her instruction into the apparatus by putting his or her finger or a stylus on the touchscreen panel. Specifically, the present invention is applicable to tablet computers, smart phones, electronic blackboards and various other electronic devices.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on U.S. Provisional Application No. 61/758,343 filed on Jan. 30, 2013 and Japanese patent application No. 2013-267811 filed on Dec. 25, 2013, the entire contents of which are hereby incorporated by reference.

What is claimed is:

1. An information processing apparatus comprising:
a touchscreen panel on which video is displayed and which accepts an operation that has been performed by a user;
a detector which detects the operation that has been performed by the user on the touchscreen panel; and
a processor which performs processing in response to the operation,
wherein if the user has performed the operation using a polyhedron input interface device which has a plurality of sides in mutually different shapes, the detector detects the shape of an area in which the input interface device is in contact with the touchscreen panel to determine which side of the polyhedron has been used to perform the operation, and the processor carries out processing that is associated with the side that has been used.

2. The information processing apparatus of claim 1, wherein if the detector senses that the input interface device contacts with the touchscreen panel at a point, the processor displays a predetermined pattern in the vicinity of the point of contact.

3. The information processing apparatus of claim 2, wherein unless the detector senses the user do any additional operation within a predefined period after the predetermined pattern is displayed, the processor zooms in on an image being displayed on the touchscreen panel by a predetermined zoom power.

4. The information processing apparatus of claim 1, wherein in a situation where a first side of the polyhedron is in contact with the touchscreen panel and where the user further performs an additional operation using a stylus type input interface device,
when the detector senses that a relative distance between the polyhedron being in contact with the touchscreen panel and the stylus type input interface device is changed, the processor changes the image being displayed on the touchscreen panel by a zoom power corresponding to the relative distance.

5. The information processing apparatus of claim 2, wherein in a situation where a first side of the polyhedron is in contact with the touchscreen panel and where the user further performs an additional operation using a stylus type input interface device,
when the detector senses that a relative distance between the polyhedron being in contact with the touchscreen panel and the stylus type input interface device is changed, the processor changes the image being displayed on the touchscreen panel by a zoom power corresponding to the relative distance.

6. The information processing apparatus of claim 1, wherein in a situation where a first side of the polyhedron is in contact with the touchscreen panel,
when the detector senses that the polyhedron input interface device being in contact with the touchscreen panel rotates around an axis that intersects at right angles with the touchscreen panel, the processor rotates an image being displayed on the touchscreen panel.

7. The information processing apparatus of claim 6, wherein the processor rotates the image being displayed on the touchscreen panel in the same rotational direction and angle as those of the input interface device that is rotated.

8. The information processing apparatus of claim 1, wherein in a situation where a first side of the polyhedron is in contact with the touchscreen panel and where the user further performs an additional operation using a stylus type input interface device,
when the detector senses that each of the polyhedron and stylus type input interface devices being in contact with the touchscreen panel rotate in the same direction, the processor rotates an image being displayed on the touchscreen panel.

9. The information processing apparatus of claim 1, wherein in a situation where a first side of the polyhedron is in contact with the touchscreen panel,
when the detector senses that the polyhedron input interface device being in contact with the touchscreen panel is dragged on the touchscreen panel, the processor changes a display range of the image being displayed on the touchscreen panel according to the direction and distance of dragging.

10. The information processing apparatus of claim 1, wherein in a situation where a second side of the polyhedron is in contact with the touchscreen panel and where the user further performs an additional operation using a stylus type input interface device,
an image object representing a ruler is being displayed on the touchscreen panel, and
when the detector senses that the stylus type input interface device moves linearly along the image object, the processor displays a linear object along the image object.

11. The information processing apparatus of claim 1, wherein in a situation where a third side of the polyhedron is in contact with the touchscreen panel and where the user further performs an additional operation using a stylus type input interface device,
when the detector senses a positional change of the stylus type input interface device, the processor recognizes a character that is drawn based on handwriting data corresponding to the positional change detected and displays the recognized character on the touchscreen panel.

12. The information processing apparatus of claim 1, wherein in a situation where a fourth side of the polyhedron is in contact with the touchscreen panel,
two types of video content which are inverted 180 degrees with respect to each other are displayed on the touchscreen panel, and have a predetermined relationship with respect to a location concerning the video content, and
when the detector senses that the polyhedron is shifted on one of the two types of video content, the processor controls presentation of the other video content so that a position of the other video content is displayed, the position corresponding to a position of the one of the two types of video content, on which the polyhedron is shifted.

13. The information processing apparatus of claim 1, wherein the input interface device includes an orientation detecting module which senses any change in the orientation of the input interface device and outputs information about the change in the orientation that is sensed,
the information processing apparatus further includes a communications circuit which receives the information about the change in the orientation, and
the processor changes display modes of an image being displayed on the touchscreen panel by reference to the information about the change in the orientation.

14. An information processing system comprising:
the information processing apparatus of claim 1;
a first input interface device in a polyhedron shape which is used to operate the touchscreen panel and which has a plurality of sides in mutually different shapes; and
a second input interface device in a stylus shape which is used to operate the touchscreen panel,
wherein when the detector senses that the first and second input interface devices are operated following a predefined rule while an image is being displayed on the touchscreen panel, the processor changes display of the image.

15. An information processing method to be carried out using an information processing system which includes:
the information processing apparatus of claim 1;
a first input interface device in a polyhedron shape which is used to operate the touchscreen panel and which has a plurality of sides in mutually different shapes; and
a second input interface device in a stylus shape which is used to operate the touchscreen panel,
the method comprising:
getting operations that are performed using the first and second input interface devices detected by the detector while an image is being displayed on the touchscreen panel;
determining whether or not the operations that are detected by the detector conform to a predefined rule; and
if the operations turns out to conform to the predefined rule, getting display of the image changed by the processor.

16. An information processing apparatus comprising:
a touchscreen panel on which video is displayed and which accepts an operation that has been performed by a user;
a detector which detects the operation that has been performed by the user on the touchscreen panel; and
a processor which performs processing in response to the operation,
wherein if the user performs the operation using an input interface device with a plurality of sides, each of which has either a different number of terminals, or terminals that are arranged in a different pattern, from any of the other sides, the detector determines the number or arrangement of terminals of the input interface device that are in contact with the touchscreen panel and the processor performs processing according to the number or arrangement of the terminals being in contact.

17. The information processing apparatus of claim 16, wherein the input interface device includes an orientation detecting module which senses any change in the orientation of the input interface device,
the information processing apparatus further includes a communications circuit which receives the information about the change in the orientation, and
the processor changes display modes of an image being displayed on the touchscreen panel by reference to the information about the change in the orientation.
